(19) United States
(12) Patent Application Publication
(10) Pub. No.: US 2015/0284035 A1
(43) Pub. Date: Oct. 8, 2015

(54) Crossmember Arrangement and Method for Production

(71) Applicant: DAIMLER AG, Stuttgart (DE)

(72) Inventor: Eckhard Reese, Apensen (DE)

(73) Assignee: Daimler AG, Stuttgart (DE)

(21) Appl. No.: 14/439,507

(22) PCT Filed: Oct. 1, 2013
(86) PCT No.: PCT/EP2013/002946

§ 371 Date: Apr. 29, 2015

(30) Foreign Application Priority Data
Oct. 31, 2012 (DE) 102012021493.631.

(51) Int. Cl. B62D 29/04; B62D 21/03; B29C 45/14

(52) U.S. Cl. CPC B62D 29/041; B29C 45/14467; B29C 45/14836; B62D 21/03; B29K 2077/00

(57) ABSTRACT

A method for the production of a crossmember arrangement for a motor vehicle involves providing the crossmember from a thermoplastic fiber-reinforced plastic tube. The fiber-reinforced plastic tube is heated at at least one joint for the attachment structure. The fiber-reinforced plastic tube is inserted, together with the attachment structure arranged on the joint, into an injection molding tool. A support pressure is applied in the interior of the fiber-reinforced plastic tube. The fiber-reinforced plastic tube is pressed in with the attachment structure. The joint is insert molded with a plastic structure.

### BACKGROUND AND SUMMARY OF THE INVENTION

Exemplary embodiments of the invention relate to a crossmember arrangement, in particular for a motor vehicle crossmember arrangement, and a method for the production thereof.

A crossmember in the cockpit of a vehicle is conventionally manufactured from steel. In this instance, the crossmember is used for the stabilization of the cockpit and to connect the steering column, airbag and dashboard. For this, various assembly means, adapter pieces and modular components are used, which are fastened to the crossmember. There are also modularly constructed cockpit regions, divided into the driver, central and passenger module, which are able to be fastened to the crossmember via various connection means. To fasten such stopping devices on the crossmember, screws, for example, may be used. Furthermore, in the case of crossmembers manufactured from steel, the possibility exists to weld such connecting structures directly on.

German patent document DE 10 2006 040 624 A1 is directed to creating a crossmember arrangement for a motor vehicle, having a highly flexible, customized and suitable modular component. This crossmember arrangement comprises a crossmember, preferably made of steel, but a tube made from fiber-reinforced plastic is also mentioned. At least one highly integrative modular component is attached to the crossmember, which serves to attach components such as a heating or air conditioning unit to the crossmember. In sections, the modular component has a mounting for the crossmember corresponding to the external profile of the crossmember, the mounting forming a contact region between the highly integrative modular component and the crossmember. The modular component, which can be designed as a casting, injection-molded part or stamped and bent part, is releasably attached to the crossmember by means of at least one fastening element that at least partially encloses the crossmember in its periphery, the fastening element can be a tab, a cable tie, a metal clamp, a hose clamp, a fastening clamp or at least one second modular component.

Based on this prior art, exemplary embodiments of the present invention are directed to an improved crossmember arrangement with respect to lightweight construction and functional integration, having improved structural properties and an appropriate and advantageous, simplified method for the production thereof.

In a first embodiment of the method for the production of a crossmember arrangement for a motor vehicle from a crossmember and at least one attachment structure connected in a non-releasable manner to the crossmember for a component that is to be attached to the crossmember, this comprises the following steps:
providing the crossmember from a thermoplastic fiber-reinforced plastic tube,
heating the fiber-reinforced plastic tube at at least one joint for the attachment structure and inserting the fiber-reinforced plastic tube, together with the attachment structure arranged on the joint, into an injection molding tool,
applying support pressure in the interior of the fiber-reinforced plastic tube,
pressing in the fiber-reinforced plastic tube with the attachment structure,
insert molding the joint with a plastic structure.

It is therefore possible to produce a crossmember arrangement in lightweight construction in few and cost-effectively implementable steps.

In one development of the method, the thermoplastic fiber-reinforced plastic tube is produced
by means of braid pultrusion or winding technology
in one piece or from several tube sections, wherein the provision of the thermoplastic fiber-reinforced plastic tube from several tube sections comprises a joining of the tube sections with the crossmember by welding, with or without spacers and/or organic sheet sections,
with constant or changeable diameter/wall thickness,

wherein the changeable wall thickness in the production process is created with winding technology or by wrapping around the complete tube with a fiber-matrix plastic material or by welding on organic sheet sections.

Furthermore, when pressing on the fiber-reinforced plastic tube, this can be contoured at least at the joint.

The injected plastic structure can be an advantageously reinforced rib structure and can consist of fiber-reinforced, preferably short fiber-reinforced, thermoplastic, preferably polyamide (PA) or polyphthalamide (PPA).

The attachment structure can furthermore, in alternative embodiments, be a load application element for an attachment point of the crossmember with a motor vehicle body, such as an A pillar, wherein the load application element can be a bush, preferably a self-stamping bush, a inlay and/or a conical element group. In this case, the inlay is inserted into one end of the crossmember before the pressing, and the bush and the conical element group are each inserted after the pressing.

The attachment structure can also be an airbag holder, a steering console and/or a tunnel brace.

The attachment structure can at least partially be produced from a thermoplastic, preferably a fiber-reinforced thermoplastic, particularly preferably from an organic sheet. The production then comprises the step of heating the attachment structure at at least one joint to the crossmember before insertion into the injection molding tool.

A carbon fiber-reinforced tube may also be used for the production of the crossmember. The method then includes the step:
generating a corrosion protection layer at least along a contact surface between the carbon fiber-reinforced tube and a metallic structural element from the group comprising attachment structures, inlays, bolts and bushes, wherein the generation of a corrosion protection layer comprises the application of a layer made from a thermoplastic, preferably a non-fiber-reinforced thermoplastic, particularly preferably from a glass fiber-reinforced thermoplastic, to the carbon fiber tube along the contact surface and/or the coating of the metallic structural element.

One embodiment according to the invention of a crossmember arrangement from a crossmember and at least one attachment structure connected non-releasably to the crossmember for a component that is able to be attached to the crossmember, the component being able to be produced by the above method, proposes that the crossmember consists of a thermoplastic fiber-reinforced plastic tube and is pressed on with the attachment structure, wherein the crossmember and the attachment structure are connected at least in a firmly bonded manner by the thermoplastic matrix of the fiber-reinforced plastic tube and are insert molded with a plastic structure.

These and other advantages are demonstrated by the description below with reference to the accompanying figures. The reference to the figures in the description serves to support the description and to facilitate understanding of the subject matter. Subject matters or parts of subject matters that are essentially the same or similar can have the same reference numerals added to them. The figures are only a schematic depiction of one embodiment of the invention.

### BRIEF DESCRIPTION OF THE DRAWING FIGURES

Here are shown:

FIG. 1 a schematic longitudinal section view of a fiber-reinforced plastic tube that is reinforced locally with welded organic sheets (due to the rotational symmetry relative to the longitudinal axis, only one half of the tube is depicted),

FIG. 2 a schematic side section view of directly welded fiber-reinforced plastic tubes,

FIG. 3 a schematic side section view of two fiber-reinforced plastic tubes that are connected by means of a fiber-reinforced plastic spacer,

FIG. 4 a schematic side section view of two fiber-reinforced plastic tubes connected by means of organic sheet connectors,

FIG. 5 a perspective view of a driver-side part of the crossmember with attachment FIG. 6 elements,

FIG. 6 a detailed section view of the crossmember/A pillar attachment point from FIG. 5,

FIG. 7 a cross-sectional view according to A-A from FIG. 6,

FIG. 8 a detailed section view of the attachment point from FIG. 7,

FIG. 9 a side section view of an adhered/pressed crossmember/A pillar attachment,

FIG. 10 a cross sectional view of the crossmember/A pillar attachment according to A-A from FIG. 9,

FIG. 11 a side section view of a crossmember/A pillar attachment with a inlay wrapped around,

FIG. 12 a side view of a crossmember/A pillar attachment with an organic sheet inlay,

FIG. 13 a perspective view for the introduction of an oval inlay into a circular fiber-reinforced plastic tube,

FIGS. 14A and 14B cross-sectional views of the fiber-reinforced plastic tube from FIG. 13 before and after the introduction of the inlay,

FIG. 15 a side section view of a crossmember/A pillar attachment with a plastic inlay,

FIG. 16 a cross-sectional view according to A-A from FIG. 15,

FIG. 17 a side section partial view of a crossmember/A pillar attachment without a inlay,

FIG. 18 a side section view of a crossmember/A pillar attachment without a plastic inlay and with a spacer,

FIG. 19 a side section partial view of a crossmember/A pillar attachment with a self-stamping, flanged bush,

FIG. 20 a side section view of a crossmember/A pillar attachment via conical elements,

FIG. 21 a perspective detailed view of the crossmember/steering console attachment,

FIG. 22 a schematic depiction for the attachment of the steering console from organic sheet material to the crossmember made from a fiber-reinforced plastic tube by heating, joining with clamping force and insert molding,

FIG. 23 a schematic depiction of a partially foamed fiber-reinforced plastic tube for increasing stiffness in a perspective view,

FIGS. 24A-24D different views of an attachment element for an airbag holder,

FIG. 25 a side section view through an injection molding tool during the insert molding process,

FIG. 26 a side view of a tunnel brace applied to the crossmember fiber-reinforced plastic tube,

FIG. 27 a sectional view through the tunnel brace along A-A from FIG. 26 without a fiber-reinforced plastic tube,

FIG. 28 a schematic side section of an attachment of the tunnel brace to the crossmember via a braiding process,

FIG. 29 a perspective detailed view of an attachment of the tunnel brace to the crossmember via a connecting piece,

FIG. 30 a side section view of a crossmember/A pillar attachment with a bush and washer.

### DETAILED DESCRIPTION

The device according to the invention relates to a crossmember and a method for the production thereof from fiber-reinforced plastic in fiber-reinforced plastic/injection molding hybrid construction technology.

To create a crossmember with low weight and high stiffness, as well as high functionality with as low manufacturing costs as possible, according to exemplary embodiments of the invention a thermoplastic, tube-shaped fiber-reinforced plastic semi-finished product is produced by means of braid pultrusion or a winding method, heating this and then introducing it into an injection molding tool together with inlays and/or attachment elements, for example to attach the crossmember to the body. In the injection molding tool, the structural elements are pressed on with one another under the influence of high internal pressure and the semi-finished product is contoured in line with the manner provided for the crossmember. Finally, the fiber-reinforced plastic tube is insert molded with plastic at least at the joints with the inlay and/or the attachment elements, the plastic preferably being fiber-reinforced.

The hollow profile that constitutes the crossmember can be formed from several tube sections to be load-capable, the tube sections also being able to have different cross-sectional sizes from one another. A fundamental aspect of the invention relates to the type of attachment of the crossmember to the body, in particular to one of the pillars (for example the A pillar). The invention furthermore relates to the attachment to individual functional components that are arranged along the crossmember and are to be connected to this. This takes place by welding and insert molding of these functional components.

A secondary aspect of the invention relates to corrosion protection, which is then particularly important if the crossmember is formed from carbon fiber-reinforced plastic. Compared to steel and aluminum, carbon fiber-reinforced plastic has a particularly high electrochemical voltage potential and can virtually be described as “noble”. Accordingly, contact corrosion arises at joints with metallic inlays, attachment elements and screws etc. with insufficient sealing against moisture.

In general, production with the correspondingly quoted techniques is designed in such a way that the fiber sequence of the fibers in the fiber-reinforced plastic tube used for the formation of the crossmember is not interrupted to the greatest degree possible or the fibers are not damaged as far as possible. Therefore, heating of at least the crossmember semi-finished product is practically unavoidable, wherein the thermoplastic matrix material becomes weak or melts and the fibers are displaced to be virtually swimming.

According to the invention, the production of the crossmember, such as in particular a motor vehicle crossmember as is found underneath the cockpit, occurs by using lightweight construction materials and strategies, using an in-mold method.

Here, the attachment points of the crossmember to the body/A pillar are of particular interest, though the crossmember/steering console, crossmember/airbag holder and crossmember/tunnel brace attachment points are also the subject matter of the invention. The joining technique plays a decisive role in the installation of endless fiber-reinforced thermoplastic fiber-reinforced plastic tubes and fiber-reinforced plastic sheets. The fiber-reinforced plastic tubes and organic sheets herein consist of a thermoplastic matrix, for example PA or PPA, and reinforcing fibers that can be glass fibers, carbon fibers or other reinforcing fibers such as aramid fibers, metal wires, metal fibers or hybrid reinforcing elements such as hybrid rovings or hybrid threads.

In the endless fiber-reinforced plastic materials used in the present instance for the production of the fiber-reinforced plastic tubes, the fiber volume proportion is approx. 60 vol. % in order to achieve the desired high level of stiffness for the crossmember, due to structural requirements—in particular NVH behavior. The joining by means of welding methods—caused by the low thermoplastic matrix proportion—is hereby rendered more difficult. The insert molding of the fiber-reinforced plastic structures is therefore provided as an alternative joining technique. In both cases, when welding and insert molding the tube, provision is made according to the invention to heat the fiber-reinforced plastic semi-finished products (join partners) and for there to be counter pressure within the tube. In order to prevent the tube from collapsing due to the injection pressure required for the joining, a support pressure (forming pressure) is required. Here, a suitable sealing of the fiber-reinforced plastic tube at the tube ends from the applied internal pressure is to be ensured.

During the production of the crossmember from endless fiber-reinforced plastics, if, for example, potentially from aspects relating to manufacturing technology, the production of the structure with endless fiber-reinforced construction is possible as a single component in a cost-effective manner, division of the crossmember into several component sections can be provided, the sections being connected/joined in an injection molding tool.

A crossmember according to the invention is produced by using a high internal pressure method (IHU method). Thermoplastic fiber-reinforced plastic tubes are used that are produced in the braid pultrusion method or by means of a winding method. During the braid pultrusion of a thermoplastic fiber-reinforced plastic hollow profile, a rotationally symmetrical, multilayer hollow profile braid is firstly produced from reinforcing fibers, the braid being impregnated in a heated tool with molten thermoplastic and then being cooled in a targeted manner, such that, after the cooling of the thermoplastic, the consolidated fiber-reinforced plastic tube is obtained. Hybrid rovings may also be advantageously used when braiding the hollow profile, the rovings comprising reinforcing fibers and thermoplastic matrix material that can be present as fibers which are located in the rovings together with reinforcing fibers, or that is present as thermoplastic matrix sizes which cover the rovings made from reinforcing fibers. The hollow profile braid therefore already contains at least one proportion of the matrix material, and indeed distributes it equally, which also later ensures, during heating, a complete and equal impregnation and consolidation of the hollow profile braid to the thermoplastic fiber-reinforced plastic hollow profile in the case of greater wall thickness.

The fiber-reinforced plastic tube semi-finished products are pressed and insert molded with the inlays and the attachment elements in an operation in an injection molding tool. To that end, an internal pressure is applied, which presses the heated tubes into the form and thus gives it its cross-sectional shape and at the same time serves as support pressure for the insert molding operation. The insert molding operation in turn serves, on the one hand, for enabling the welding of the elements to one another and, on the other, for reinforcing the connecting elements with injected ribs.

The design of the crossmember and the attachment elements is described below. It is proposed, when considering the design of the crossmember, for the crossmember to undergo different stresses by attaching the individual elements, such as steering console, tunnel brace or airbag holder, in different regions. It is therefore, in general, more heavily stressed on the driver side, for example, than on the passenger side. Accordingly, the crossmember should be adapted in its cross-section to the different stresses.

The crossmember can be designed as a continuous profile. The previously manufactured fiber-reinforced plastic tubes are used here. Within the framework of the winding process, these may be produced with a variable cross-section in order to adapt the crossmember to the different stresses. In the winding process, the fiber angle and the wall thickness can be varied very well and can be adapted to the stresses.

The fiber-reinforced plastic tube manufactured in this way is heated and inserted into the crossmember form provided for this, together with the attachment elements. Then an internal pressure is applied, which presses the fiber-reinforced plastic tube into the form. There then takes place an insert molding process in order to support the connection of crossmember and attachment elements.

Alternatively, the crossmember can be designed with a constant cross-section without adapting the cross-sections. Here, the fiber-reinforced plastic tube can be produced both by winding technology and by means of braid pultrusion, wherein, in this case, the adaptation of the cross-section to the stress is omitted or reinforcement is provided locally.

For this, one possibility can consist in that a pultruded tube can be wrapped around locally depending on the stress. At points of greater stress, more material is applied accordingly. For this, a prepreg band, for example having laser-supported ring winding heads, can be deposited onto the pultruded tube. Here, the cross-section can be adapted locally very well. The winding heads deposit the tapes/prepreg bands at the desired position and the prepreg bands are at least partially melted with the energy introduced by the laser. Thus, the adhesion between fiber and matrix, as well as the adhesion on the tube, is achieved. Then the tapes are pressed with a roll onto the tube. Then this tube, together with the inlays/attachment elements provided, undergoes the described IHU process.

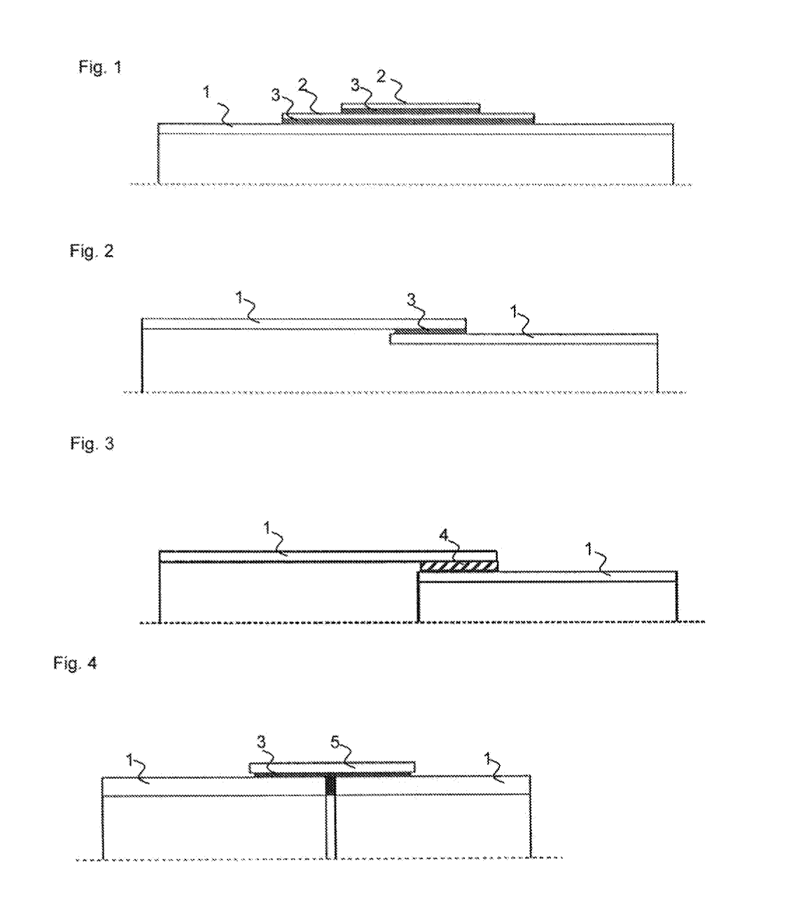

FIG. 1 shows a fiber-reinforced plastic tube 1 having locally welded organic sheets 2 for reinforcement in order to take account of the locally different stresses of the crossmember, if a continuous tube 1 of the same cross-section is used. After being produced, for example by means of braid pultrusion, the tube 1 is reinforced with organic sheets 2 in regions of higher stress or at attachment points of the individual components. To that end, it first proceeds as described for the continuous profile. In addition, heated organic sheets 2 are inserted into the crossmember form at the points of higher stress, the sheets also being welded under pressure with the tube 1 forming the crossmember and reinforcing this locally. The internal pressure again herein serves for the stabilization of the tube 1 from collapsing and for the shaping of the crossmember tube 1. The organic sheets 2 are welded to the fiber-reinforced plastic tube 1 in a firmly bonded manner by temperature and pressure through the matrix material that forms the weld 3 and is at least melted and hardened again.

The different stresses may be taken into consideration by the division of the crossmember into individual sections 1 of different or constant cross-section. The thermoplastic fiber-reinforced plastic sections produced by means of braid pultrusion or in a winding method are heated and inserted, together with the attachment elements, into the crossmember forming tool. There are several variants for the connection of the individual sections 1 of the crossmember, which are described in conjunction with FIGS. 2 to 4.

The first variant, which requires no additional elements, consists in that the ends of the individual tubes 1 are tapered or widened and are pressed into one another in the injection molding tool (see FIG. 2). The end of the tube 1 depicted on the left with the larger diameter receives the tube end of the second tube 1, such that the weld 3 with the molten matrix material takes place in the overlap. Due to the welding of the sections 1, there arises a firm bond, whereas, at the same time, when pressing the ends of the sections 1, a positive fit is generated by the shape of the crossmember, which is non-round at least in this region, said crossmember forming anti-twist protection.

A joining alternative for tubes with different diameters can be seen in FIG. 3. There, the sections 1 that have been manufactured with different diameters are connected by an additional element 4 which, for example, can be a fiber-reinforced plastic spacer 4. This is introduced between the heated, overlapping fiber-reinforced plastic tube ends 1 and is pressed on with these. A firm bond can thus be generated by welding the spacer 4 to the tubes 1.

Furthermore, as is shown in FIG. 4, the connection of the crossmember parts 1 can occur via a thermoplastic, fiber-reinforced connecting piece 5, which is laid around the connection point of the tube sections 1 that are formed here with the same diameter (analogously to the connecting piece 5 for the attachment of the tunnel brace, see FIG. 29). For this purpose, an organic sheet can be heated as a connecting piece 5 and can be welded to the crossmember parts 1 under pressure. There thus arises a firmly bonded connection between the connecting piece 5 and the tube ends 1.

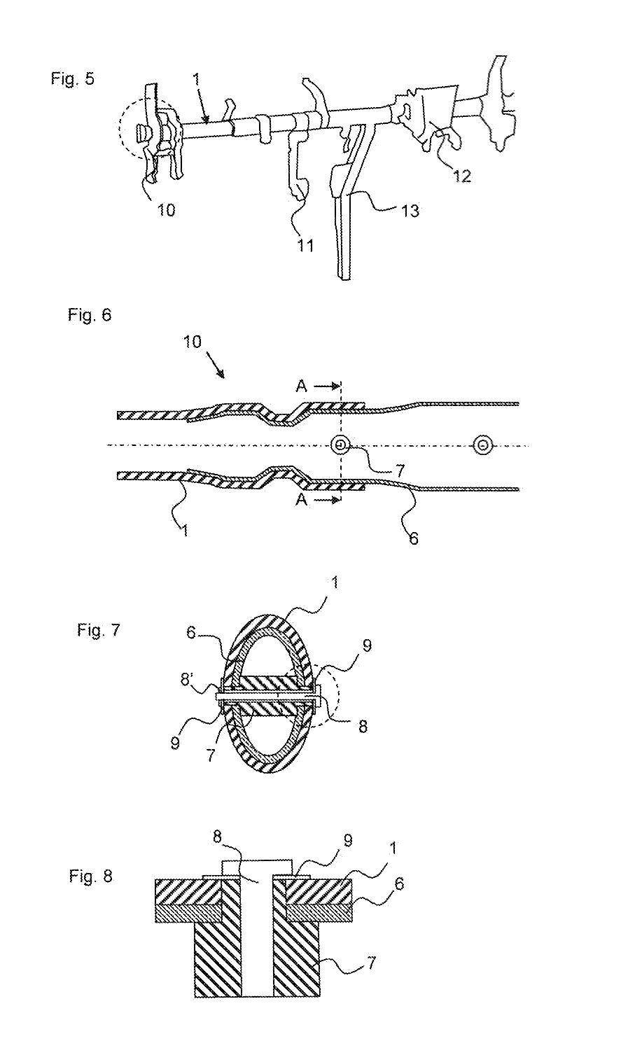

A driver-side section of a fiber-reinforced plastic crossmember 1 according to the invention is depicted in FIG. 5 with various attachment elements such as the attachment element 10 to the A pillar, the airbag holder 11, the tunnel brace 13 and the steering console 12.

The crossmember/A pillar attachment that can take place by means of metal inlays is illustrated in FIGS. 6 to 8. FIG. 6 is a detailed section of the crossmember/A pillar attachment 10, which is marked in FIG. 5 with the dotted circle. The attachment of crossmember and cockpit occurs at the A pillars by means of screwing. Since the crossmember 1 consists of a fiber-reinforced plastic tube 1, the flow of the material under sustained load, which has as a consequence a decrease in the pre-tension force of the screw connection, is a main problem in the attachment of the crossmember to the A pillar. This problem is confronted by introducing a metallic load application element into the fiber-reinforced plastic tube 1. The load application element, which in the present instance is an inlay 6, can, for example, be designed from stainless steel and is connected to the fiber-reinforced plastic tube 1 by means of a combined joining method. The attachment of the inlay 6 to the fiber-reinforced plastic tube 1 occurs here by a firm bond and positive fit. The positive fit is achieved by pressing the fiber-reinforced plastic tube 1 that has been heated at its ends onto the inlay 6 and guarantees both axial securing and anti-twist protection. Then a self-stamping bush 7 is introduced into the crossmember, through which a bolt 8 is guided. In order to prevent the fiber-reinforced plastic material from flowing on the support of the bolt head or the nut 8′, flat washers 9 can be used. The surface load there is hereby minimized. If carbon fibers are used as the reinforcing fibers in the composite material, the proposition is made to take precautions in order to prevent contact corrosion between the metallic inlay and the carbon fibers.

Such precautions may, for example, be intermediate layers made from pure thermoplastic material without reinforcing fibers or made from a non-carbon fiber-reinforced, thermoplastic material, or may even be coatings that prevent the corrosion of the inlay. Such coatings may be applied with various methods for surface coating. The corrosion problem only generally occurs in the case of carbon fiber-reinforced materials.

In order to achieve further reinforcement of the joint between the fiber-reinforced plastic tube 1 and the inlay 6, insert molding of the fiber-reinforced plastic tube 1 and the inlay 6 is undertaken. Here, a rib structure is generated, which leads to stiffening. A further advantage of the insert molding is the improvement in adhesion. In order to achieve this level of adhesion between the metal inlay and the thermoplastic material, pre-treatment of the metal part is required. This pre-treatment—the priming—enables a firm bond between the plastic and metal. To prevent the fiber-reinforced plastic tube 1 from collapsing as a result of the injection pressure, internal pressure is to be applied in an appropriate manner, the details of which are illustrated below. The screwing of the crossmember and A pillar occurs by means of a self-stamping bush 7 introduced into the inlay 6 and a screw connection 8.

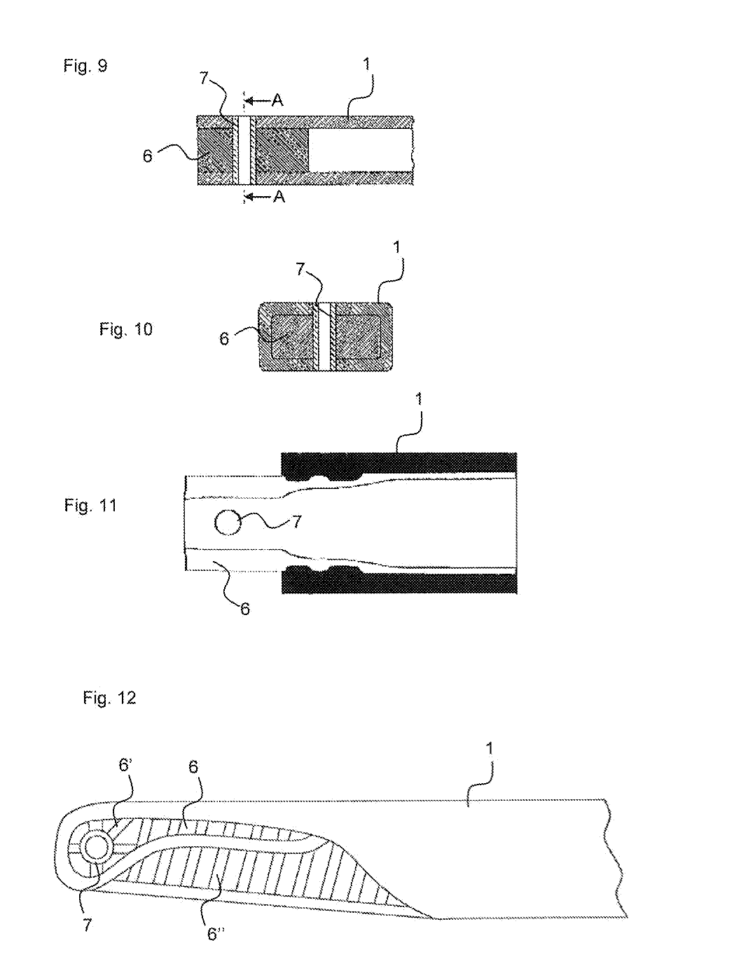

A further variant consists in the use of a massive metal inlay 6 that is provided with a bore-hole (see FIGS. 9 and 10). This is connected to the fiber-reinforced plastic tube 1 in a firmly bonded and positive manner. To that end, the fiber-reinforced plastic tube 1 is first heated and pressed and adhered to the inlay 6 in a working step. Thus, on the one hand, anti-twist protection is produced by the positive fit and, on the other, a firmly bonded connection between the inlay 6 and the tube 1 is produced by the adhesion. A self-stamping bush 7 is then introduced. Here, a highly precise positioning of the bush 7 and inlay 6 or the bore-hole introduced into the inlay 6 is required. There is alternatively the possibility of producing the bore-hole of the fiber-reinforced plastic tube 1 before the insertion of the bush 7, for example by lasering, and then introducing a non-self-stamping bush 7. In this variant, attention should also potentially be paid to sufficient corrosion protection, as described above.

Further possibilities for the attachment of the crossmember to the A pillar arise from an amended production process for the crossmember. Here, there is processing with an aluminum core 6 remaining in the later component (see FIG. 11), i.e., the tube is wound or braided onto the aluminum core 6. This aluminum core 6 consists of an aluminum tube structure. The aforementioned inlay can hereby be dispensed with, since the functions of the inlay are performed by the core 6 as a load application element. For this, the geometry of the core 6 is designed as follows: The core ends are designed to be thicker according to the stresses for the screwing between the A pillar and crossmember, whereas the central part of the core 6 has the shape of a thin-walled tube. Endless fiber-reinforced, thermoplastic tapes are applied to the prepared core in a winding process by means of winding technology and consolidated into the fiber-reinforced plastic tube 1. The connection between the fiber-reinforced plastic material and aluminum occurs, on the one hand, by a positive fit, for example by positive fit elements introduced to the exterior surface of the core 6, such as depressions, and on the other hand by a firmly bonded connection created by priming the aluminum surface in a pre-treatment step before the winding process. The attachment between crossmember and A pillar takes place by screwing and a self-stamping bush 7 that is introduced into the crossmember. In order to prevent corrosion between the carbon fiber-reinforced tube and the metal core when carbon fibers are used, a glass fiber-reinforced intermediate layer can, for example, be fed in.

FIG. 12 shows a further variant of the crossmember/A pillar attachment. In order to achieve further weight reductions and to counteract the corrosion problem, the use of an organic sheet inlay 6 is provided. An organic sheet is described as an endless fiber-reinforced thermoplastic plate. For this, the organic sheet inlay 6 is insert molded with a star-shaped rib structure 6′ in an upstream process step. A force application element is provided in the center of the rib structure 6′ with a self-stamping bush 7. The self-stamping bush 7 is introduced here using the one-shot method and is flanged at its ends. A higher load-bearing capacity and higher twisting torque of the bush 7 can hereby be achieved. The rib structure 6′ is herein applied from a fiber-reinforced thermoplastic injection material.

The rib structure 6′ serves for the later, problem-free welding between the fiber-reinforced plastic tube 1 and the organic sheet inlay 6. In preparation for the welding process, the fiber-reinforced plastic tube 1 is heated to above the melting point of the thermoplastic matrix material under the influence of an infrared heater outside the tool activity and is plated at its ends. Subsequently, the plated fiber-reinforced plastic tube 1 is welded to the insert molded organic sheet inlay 6 and is insert molded with a further rib structure 6″. Both of these occur as part of the tool activity of the injection molding machine. The rib structure 6″ is responsible for the required stiffness of the crossmember at its ends, since, due to the plating of the tube 1, considerable losses with respect to resistance from buckling are otherwise to be expected.

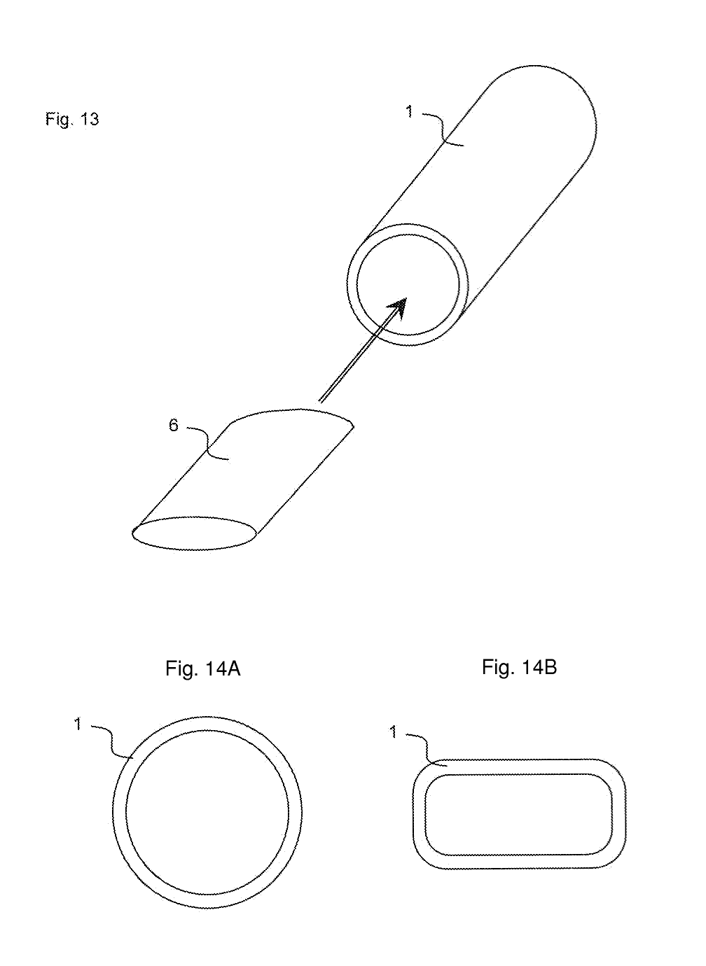

A further variant of the attachment of the crossmember to the A pillar is indicated in FIG. 13 and consists in the use of a massive plastic inlay 6 remaining in the fiber-reinforced plastic tube 1. It has the same circumference as the fiber-reinforced plastic tube 1, yet has an oval, in particular elliptical cross-section, and is provided in advance with a bore-hole (not depicted in FIG. 13). Before the introduction of the inlay 6, the fiber-reinforced plastic tube 1 has a round cross-section (see FIG. 14a). The fiber-reinforced plastic tube 1 is now heated and the inlay 6 is slid into the tube 1 by means of a bevel, such that the tube 1 is brought into a flattened shape that deviates from a circle before the actual molding process and after the insertion of the inlay 6, as is depicted in FIG. 14b. According to the inlay cross-section, the tube can also obtain an oval or elliptical cross-section after the insertion of the inlay in this section.

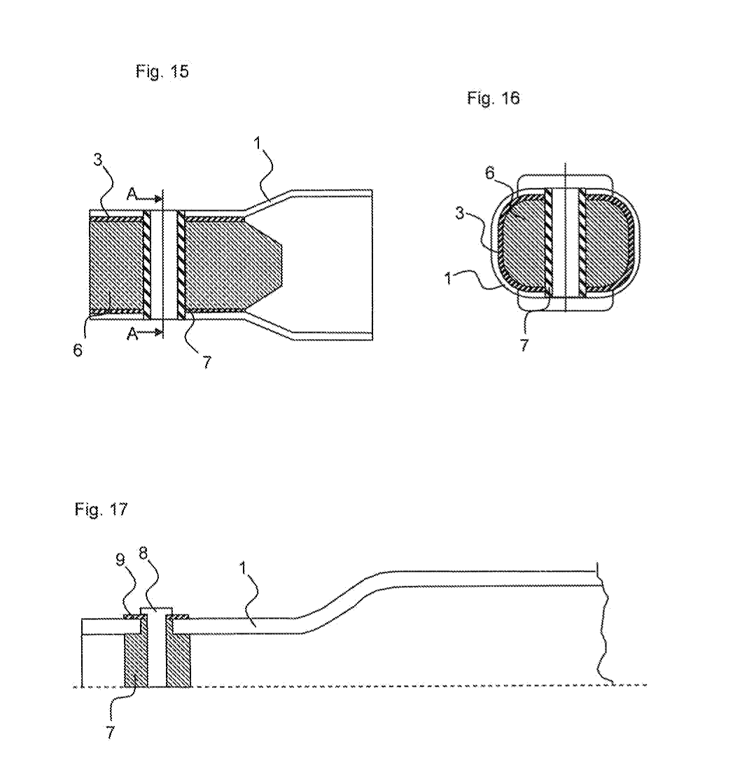

Then both are introduced into the crossmember tool and pressed together in the injection molding machine. The completely produced connection is depicted in a longitudinal section view in FIG. 15 and in a cross-sectional view in FIG. 16. By pressing the heated fiber-reinforced plastic tube 1 with the plastic inlay 6, a positive fit and a firm bond arise. The positive fit arises due to the non-round shape of the fiber-reinforced plastic tube 1 forming the crossmember and features anti-twist protection. By welding the fiber-reinforced plastic tube 1 and the plastic inlay 6—this is represented by the matrix plastic layer 3 forming the weld—the firm bond is generated. Following the injection molding process, a bush 7 is introduced, as with the massive metal inlay. For this, under the prerequisite of highly precise positioning, a self-stamping bush 7 can be introduced. Alternatively, the bore-hole can be introduced into the fiber-reinforced plastic tube structure in advance, for example by lasering. The advantages over the metal inlay consist in the resulting weight reduction and the improved connection that can be achieved by welding compared to adhesion.

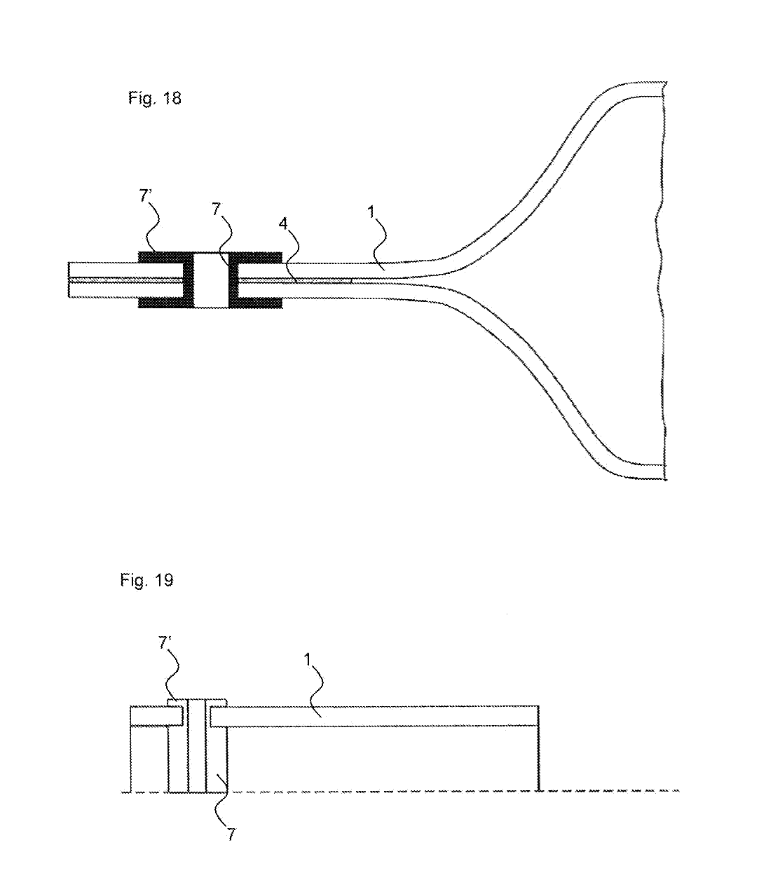

A further possibility for the attachment between the crossmember and A pillar features connection without a load application element, as is depicted in FIG. 17. A metallic inlay can hereby be dispensed with. This particularly involves weight advantages compared to the variant with a metallic inlay. The load application into the fiber-reinforced plastic tube 1 herein occurs by screwing between the A pillar and the crossmember. For this, self-stamping bushes 7 are introduced into the end section of the crossmember and are fixed by pressing on the fiber-reinforced plastic tube 1. In order to obtain as much surface pressure as possible underneath the screw head 8 and thus to prevent the fiber-reinforced plastic material from flowing, flat washers 9 are used. In order to prevent setting of the screw pre-tension force, it should be ensured that the fiber-reinforced plastic tube 1 has an oversize compared to the self-stamping bush 7.

By tightening the screw 8, the fiber-reinforced plastic material is hereby made to flow and the screw 8 becomes solid with the self-stamping bush 7. A later setting of the screw 8 is hereby prevented and a durable tension is achieved. If the fiber-reinforced plastic tube 1 has not been produced with an oversize compared to the self-stamping bush 7, a retightening of the screw 8 to the defined tightening moment in defined intervals is to be ensured. For a further introduction of force into the fiber-reinforced plastic tube 1, the end piece of the tube 1 can potentially be foamed after the setting of the self-stamping bush 7. A series of technical foams such as a PUR foam are provided for this.

For the connection between the crossmember and A pillar, a method can be furthermore be used in which a bush 7 is introduced with a centrally attached spacer 4 (see FIG. 18). For this, the bush 7 is inserted into the fiber-reinforced plastic tube 1 and the tube 1 is pressed around the bush 7. The tube 1 is flattened here. The spacer 4 has, in this connection, the task of preventing fiber damage as a result of bending radii that are too small. After the self-stamping bush 7 has penetrated the fiber-reinforced plastic tube 1, a plastic reshaping of the same takes place. Here, the bush ends 7′ protruding above the edge fibers of the flattened fiber-reinforced plastic tube 1 are folded over. A positive and firmly bonded connection between the crossmember 1 and bush 7 is formed. Within this concept, a foaming of the edge region of the tube is also possible. The stability of the crossmember connecting piece is hereby increased.

In order to further optimize the force introduction into the crossmember 1, a further concept based on a self-stamping bush 7 introduced into the fiber-reinforced plastic tube 1 is provided, as is outlined in FIG. 19. For this, the self-stamping bush 7 is flanged at both ends after the stamping process (in FIG. 19, only half of the tube 1 and the corresponding half of the bush 7 are depicted; due to symmetry, the same applies for the second bush end). For this stamping process, the tube 1 must be heated at its ends, since it has to be compressed or ovalised to a certain extent in order for a penetration of the bush 7 through the fiber-reinforced plastic material to be possible. The force introduction from the A pillar into the crossmember 1 herein takes place via traction, wherein the force introduction from the bush into the fiber-reinforced plastic tube occurs by a positive connection.

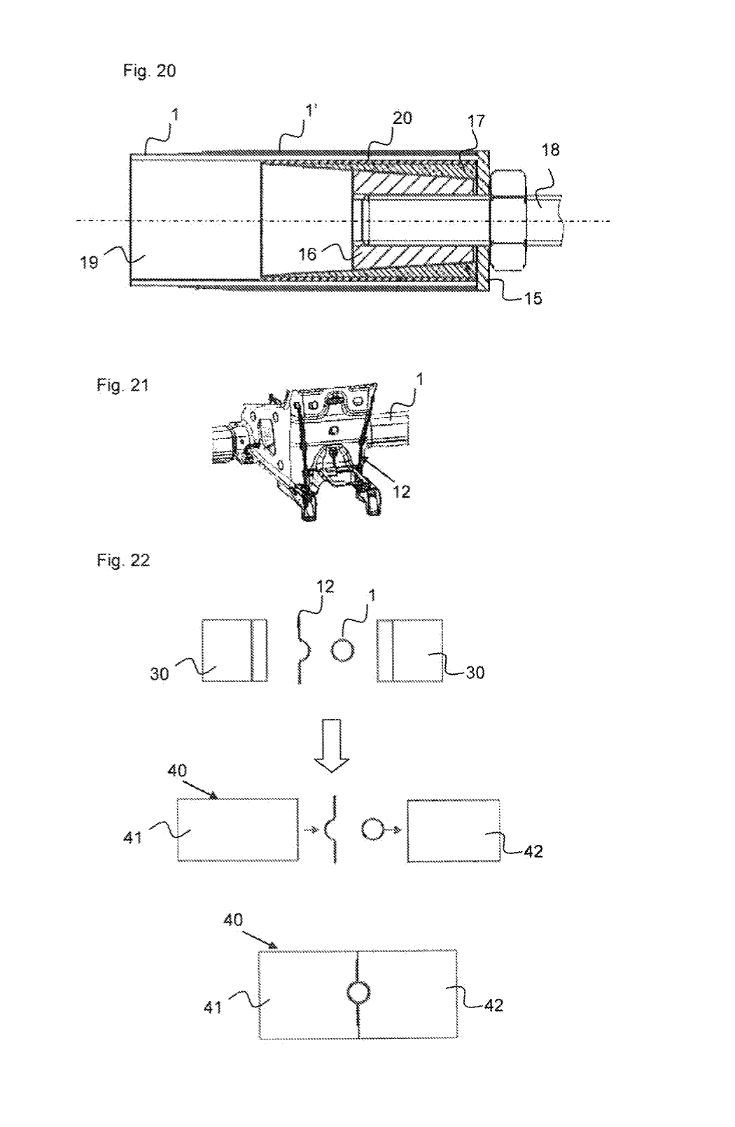

The crossmember and A pillar attachment by means of tensioning via a conical element is shown in FIG. 20, which represents a further possibility for the attachment of the load application element. A subsequent assembly of the attachment element is hereby possible. The complete attachment herein occurs by means of a pressure ring 15, an outer cone 16 (for example made from aluminum), an inner cone 17 (for example aluminum) and a screw element 18. The functionality is hereby represented as follows: The inner cone 17 and the outer cone 16 are introduced into the tube 1 that has been prepared by means of a peripheral winding 1′ with a fiber-reinforced plastic material, for example, carbon fiber-reinforced, and are tensioned with the fiber-reinforced plastic tube 1 by means of a traction bolt 18. A flowing of the fiber-reinforced plastic tube 1 is prevented by the peripheral winding 1′ and the tension required for the load application is applied. The corrosion between the carbon fibers and the aluminum can be counteracted by glass fiber intermediate layers 20. Support against pressure forces and a further reinforcing of the crossmember 1 can take place by foaming 19 the hollow profile.

The attachment of the steering console 12 to the crossmember 1 made from fiber-reinforced plastic tube is shown below (see FIG. 21). The attachment of the steering console 12 is also carried out by a combined joining process, wherein a classic welding method is also combined here with the insert molding. The steering console construction 12 is a construction made from insert molded organic sheets. For the attachment of the steering console 12 to the fiber-reinforced plastic tube 1, the join partners are first heated in the region of the joints (see FIG. 22). The heating of the joints can herein take place, as depicted, by infrared heaters 30 or, for example, by hot gas. The heating is a process taking place upstream of the injection process and is undertaken outside the tool 40. The actual joining process takes place in the injection molding tool 40. Due to the clamping force of the tool 40, which comprises a clamp side 41 and a nozzle side 42, the required joining pressure is applied and a first welding of the components 1, 12 is undertaken. Now, insert molding of the structure that had previously be joined in the injection molding method by means of clamping force is subsequently carried out for reinforcement and to enlarge the joining surface, wherein the joint of the steering console 12 joined to the crossmember 1 is insert molded. A short fiber-reinforced thermoplastic (e.g. PA, PPA) is, for example, suitable for the insert molding.

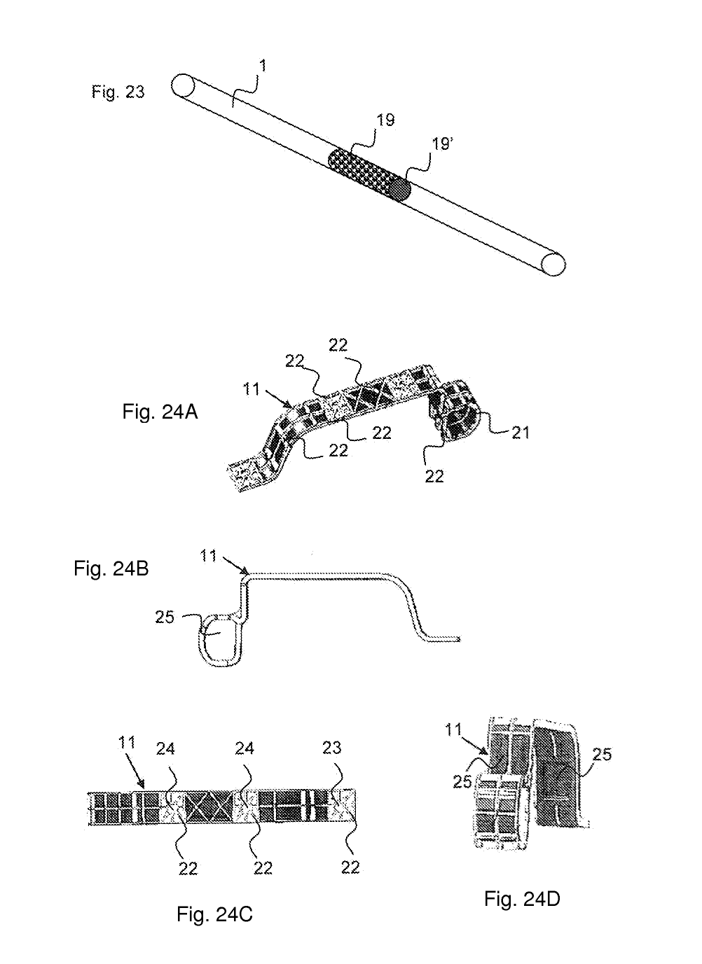

For applications with particularly high stiffness and strength requirements in the region of the steering console/crossmember attachment (or even in other regions with increased strength requirements), a partial foaming of the fiber-reinforced plastic hollow profile 1 forming the crossmember 1 can additionally be undertaken, as is depicted in FIG. 23. To increase strength, the fiber-reinforced plastic tube 1 is partially filled with a foam 19 in the region provided for the arrangement of the steering console, said regions being bordered by a foam barrier 19′. Technical foams such as PUR foams are used for this. The foaming can herein take place chemically or physically. The foam barriers may be formed here by the foams themselves. The filling of the crossmember 1 occurs either from sides of the open side of the hollow profiles or by bore-holes introduced into the hollow profile, via which the foam or the foam precursor is introduced.

A further attachment element provided on the crossmember 1 is an airbag holder 11, which is shown in FIGS. 24a-d in a perspective top view (a), a side view (b), a top view (c) and a perspective front view (d). The airbag holder 11 is embodied in a construction consisting of organic sheet 21 and injected ribs 22. For this, the heated organic sheet is inserted into the tool and is insert molded with a thermoplastic. In the side view (FIG. 24b) of the airbag holder 11, the opening 24 provided for receiving the crossmember can be seen. The openings 24 enclosed by a star-shaped rib structure 22 for reinforcement (FIG. 24c) are the screw-on points for the airbag; the opening 23 is provided as the screw-on point to the crossmember. The bulges 25 that can be recognized in FIG. 24d (also known as “domes”) introduced into the flat sections of the airbag holder 11 additionally serve to improve the strength.

To connect the airbag holder to the connection, the organic sheet structure heated at the joint and the fiber-reinforced plastic tube that has also been heated at the joint are introduced into the tool, in which the welding and the insert molding of fiber-reinforced plastic tube and organic sheet structure takes place to form a firmly bonded connection between the parts. This has been ascribed to the melting of the thermoplastic matrix of both the organic sheet structure and the fiber-reinforced plastic tube. Ribs are injected on to reinforce the components. The construction of the airbag holder can be seen analogously to the construction of the steering console.

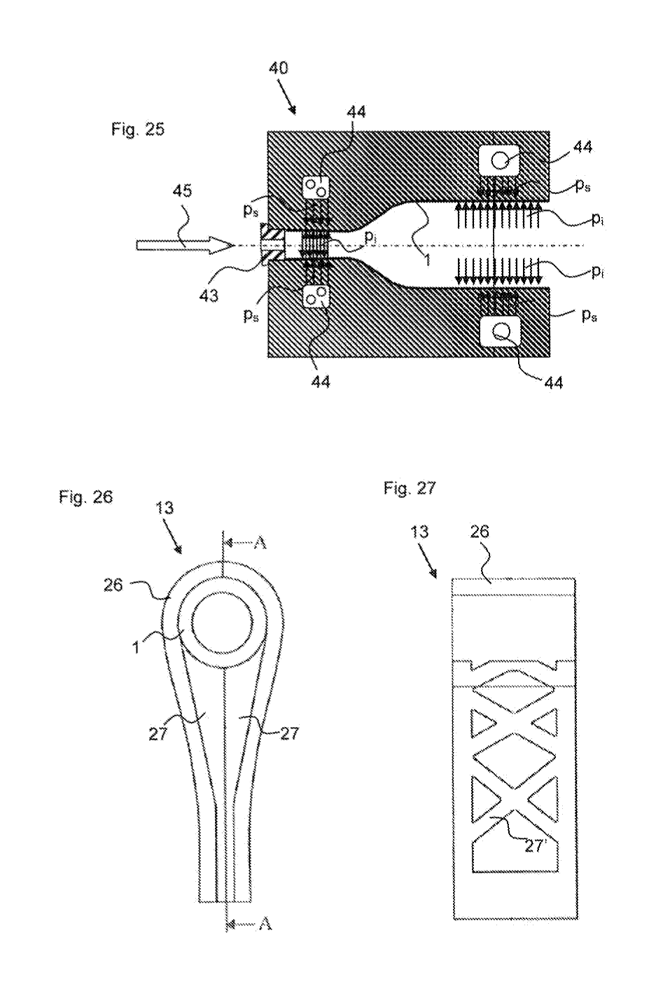

Further individual components such as further airbag holders (e.g. kneebag), the holder for an AC unit or for an AC unit component, the wiring harness holder and the central console holder are also injected on in the injection molding method. For this, a short fiber-reinforced thermoplastic is also preferred. The attachment of the aforementioned individual components takes place here by a firm bond. The firmly bonded connection is supported by a respective upstream heat treatment of the fiber-reinforced plastic tube. It proceeds analogously to the method described for the attachment of the steering console. In this case, the heating of the matrix material of the fiber-reinforced plastic tube by an infrared heater is also achieved before inserting the fiber-reinforced plastic tube into the tool. The support of the tube 1 against the injection pressure pₛ also herein occurs by an application of pressure pᵢ of the tube interior with a fluid, so a gas or an hydraulic liquid (see FIG. 25). The cavity of the tool 40 is sealed with a pierced plug 43, through which the supply of the liquid for generating the support pressure pᵢ takes place. The arrow 45 symbolizes the connection to a pressure generation unit. The support pressure pᵢ is selected in such a way that a collapse of the fiber-reinforced plastic tube 1 due to the injection pressure ps applied by the plastic injection units 44 is prevented. A further possibility for support against injection pressure provides methods with meltable lost cores. Here, materials such as metal alloys with a low melting point may be used.

The attachment of the tunnel brace 13 to the crossmember is described below in connection to FIGS. 26 and 27. The attachment of the tunnel brace 13 can take place via a welding method. The starting materials for the tunnel brace 13 in FIG. 26 are two organic sheet half shells 26. These half shells 26 are welded and insert molded to the fiber-reinforced plastic crossmember underneath the cockpit 1 analogously to the method envisaged for the steering console. Ribs 27 are also introduced here to reinforce the structure. In an upstream process step, ribs 27′ are injected onto the inner sides of the organic sheet half shells 26 (see FIG. 27), in order to ensure the required level of stiffness of the tunnel brace 13 after the welding. In the sectional depiction shown in FIG. 27 of the tunnel brace 13 along A-A from FIG. 26, the fiber-reinforced plastic tube is not depicted in order to better show the inner ribbing of the organic sheet half shells 26.

Hybrid webs are, for example, used as reinforcing fibers in the organic sheet semi-finished products 26. These hybrid webs consist of different materials, such that an adaptation of the organic sheets 26 to the existing load conditions is made easy. Since the tunnel brace 13 is a crash-stressed component, securing the tunnel brace 13 from intruding into the passenger compartment is to be provided. Here, reinforced organic sheets are provided, in particular in addition to carbon fibers with steel wires. The ductility of even these organic sheet constructions is hereby increased and a brittle fracture malfunction upon crashing can be counteracted, since the individual parts resulting from brittle fracture still form a residual compound due to the far more ductile steel wires.

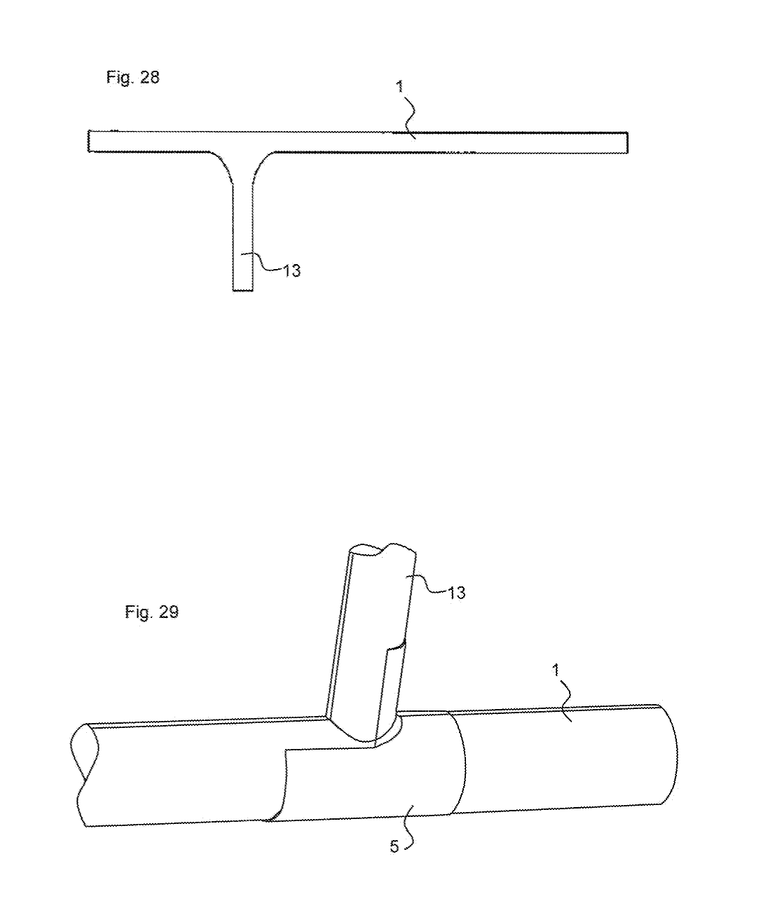

A second possibility for the attachment of the tunnel brace 13 to the crossmember 1 is the direct integration of the tunnel brace 13 into the crossmember 1, as is denoted in FIG. 28. This possibility is provided for small batches, since a continuous process for the crossmember production is not possible. For this, the crossmember tunnel brace structure is braided, i.e. the attachment of the tunnel brace 13 to the crossmember 1 takes place via a braiding process. Then the crossmember tunnel brace structure is consolidated in a tool. In this variant, no joint advantageously exists between the crossmember 1 and the tunnel brace 13. The lightweight construction potential of the fiber-reinforced plastic materials is hereby fully exploited by functional integration. Known problems such as insufficient strength in the joining region due to lack of fiber reinforcement are thus avoided. In particular, the stiffness of the entire crossmember structure can be increased by the combination of crossmember 1 and tunnel brace 13. In line with the consolidation, an additional ribbing on the tunnel brace 13 can additionally be undertaken. This ribbing may be used to increase the stiffness of the construction.

A further possibility for the attachment of the tunnel brace 13 to the crossmember 1, which is depicted in FIG. 29, is a connecting piece 5 made from a fiber-reinforced thermoplastic material from a customized organic sheet. This organic sheet is heated and laid around the parts 1, 13 to be connected. A firmly bonded connection is now generated under pressure; the organic sheet piece 5 is then welded to the crossmember 1 and the tunnel brace 5.

In the case of carbon fiber-reinforced materials and metallic elements being used, measures for anti-corrosion protection of the materials are of great significance due to the large electrochemical potential difference. The corrosion problem particularly plays a significant role for the crossmember/A pillar attachment, since metallic connecting elements such as self-stamping bushes and load application elements are provided here. In the case of the inlays, the corrosion problem can be counteracted with the aid of intermediate layers made from glass fiber-reinforced plastic. Here, the glass fiber-reinforced plastic layer is the sole touching layer between the metallic inlay and the carbon fiber-reinforced material. Due to the lack of conductivity of the glass fibers, the corrosion problem is constructively solved. When using self-stamping bushes, intermediate layers made from glass fiber-reinforced plastic are not considered, since the bush penetrates the complete diameter of the carbon fiber-reinforced material. In the case of the self-stamping bush, a different possibility for corrosion protection is therefore to be preferred. Coatings of the bush for preventing corrosion are herein considered. Such coatings may be galvanic or may also be applied by other layer-forming processes. A further possibility provides the substitution of the material of the metallic inlay or the metallic bush. By using titanium or stainless steel instead of aluminum, the potential difference between the metallic component and the carbon fiber-reinforced material can be reduced by one fifth of the original value.

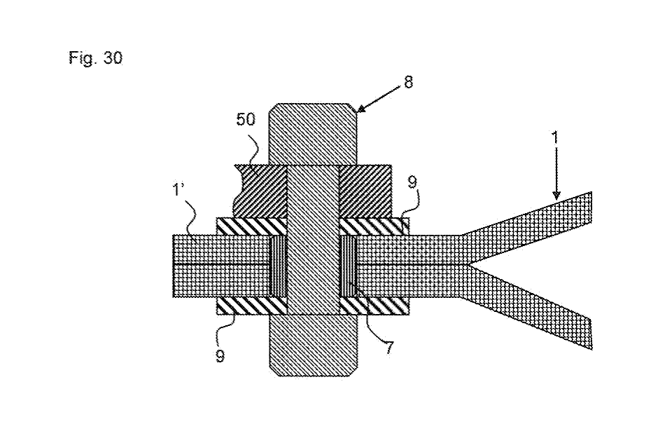

A corrosion-suitable design of the attachment to the A pillar 50 is depicted in FIG. 30. Here, a UD-reinforced glass fiber bush 7 can be used. It is therefore irrelevant as to whether, as depicted in FIG. 30, the ends 1′ of the carbon fiber-reinforced tube 1 are pressed or whether one of the other envisaged variants is used. The attachment of the crossmember to the A pillar 50 occurs via screwing 8. In order to prevent corrosion between the metal of the screws 8 and the carbon fiber-reinforced material, the bush 7 made from glass fiber-reinforced plastic is used. To that end, an opening is introduced into the tube end 1′ before the insertion of the bush 7, for example by lasering. Then the bush 7 is pressed in. To prevent flowing of the matrix of the carbon fiber-reinforced plastic tube 1 and to guarantee an extensive load introduction into the carbon fiber-reinforced plastic tube 1, flat washers 9 are provided, which may also be manufactured from glass fiber-reinforced plastic, in order to avoid direct contact of a screw head or a nut with the carbon fiber-reinforced material of the crossmember 1.

The entire process for the production of the crossmember arrangement with the various attachment points is divided into four or five partial processes in total:
Heating the fiber-reinforced plastic tube at the joints and heating the attachment parts, preferably via infrared heaters.
Inserting, joining and insert molding the components into the injection molding machine.
Removing the crossmember with the attachment elements and heating the same at its ends.
Sliding the load application elements or self-stamping bushes onto the ends and pressing the ends.
If necessary, insert molding the inserted load application element and introducing a bolt.

Due to the design of the crossmember according to the invention underneath the cockpit in fiber-reinforced plastic construction, large weight reductions are possible. These weight reductions may contribute to reducing the fuel consumption of the motor vehicles and thus achieving the set targets for CO₂ emissions. From an economic standpoint, this is a considerable competitive advantage. The technical advantages, as well as a weight reduction and improved driving performance of the motor vehicles accompanying this, particularly lie in the suitable joining techniques for fiber-reinforced plastic materials that are used in the present instance. In contrast to conventional connecting techniques such as screwing or riveting, a range of improvements is possible by welding and insert molding. Included in this is, among other things, the improved exploitation of the mechanical material properties by eliminating joining methods that damage the fibers. When both screwing and setting down rivet connections, damage to the fibers remains, and thus a reduction in the strength of the component. Classical problems of connection technology, in particular in the case of thermoplastic composite materials such as bearing stress in screw and bolt connections, are ruled out by the application of welding methods. In addition, the introduction of weight-increasing elements is dispensed with by the omission of joining elements. The lightweight construction potential of the fiber composite materials is hereby completely exploited. By preventing apertures through the composite structure, the corrosion problem on sides of the composite material is also minimized, since an intrusion of moisture and other corrosive media is prevented. A sealing of the structure can hereby optionally be dispensed with and a process step can be saved. As a result of this, costs can be saved to a not inconsiderable degree. In addition, by dispensing with connecting aids such as screws or rivets, anti-corrosion prevention during the use of metallic components becomes simpler, since only one position of the fiber-reinforced plastic material comes into contact with the metallic component.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for the production of a crossmember arrangement for a motor vehicle from a crossmember and at least one attachment structure that is connected to the crossmember in a non-releasable manner for a component that is to be attached to the crossmember, the method comprising the steps:
providing the crossmember from a thermoplastic fiber-reinforced plastic tube;
heating the fiber-reinforced plastic tube at at least one joint for the at least one attachment structure;
inserting the fiber-reinforced plastic tube, together with the at least one attachment structure arranged on the at least one joint, into an injection molding tool;
applying support pressure in an interior of the fiber-reinforced plastic tube;
pressing in the fiber-reinforced plastic tube with the attachment structure; and
insert molding the at least one joint with a plastic structure.

12. The method of claim 11, wherein the thermoplastic fiber-reinforced plastic tube is produced:
using braid pultrusion or winding technology;
in one piece or from several tube sections, wherein the provision of the thermoplastic fiber-reinforced plastic tube from several tube sections comprises a joining of the tube sections with the crossmember by welding, with or without spacers or organic sheet sections;
with constant or changeable diameter/wall thickness, wherein the changeable wall thickness in the production process is created with winding technology or by wrapping around the complete tube with a fiber-matrix plastic material or by welding on organic sheet sections.

13. The method of claim 11, further comprising the step:
contouring, during the pressing, the fiber-reinforced plastic tube at least at the joint.

14. The method of claim 11, wherein the injected plastic structure is a rib structure and consists of a fiber-reinforced, thermoplastic material, which is polyamide (PA) or polyphthalamide (PPA).

15. The method of claim 11, wherein the attachment structure is
a load application element for a connecting point of the crossmember to an A pillar, wherein the load application element comprises a self-stamping bush, an inlay, or a conical element group, wherein the inlay is introduced into one end of the crossmember before the pressing, and the bush and the conical element group are each introduced after the pressing,
an airbag holder,
a steering console, or
a tunnel brace.

16. The method of claim 11, wherein the attachment structure is at least partially manufactured from a fiber-reinforced thermoplastic made from organic sheets, the method further comprising the step:
heating the attachment structure at at least one joint to the crossmember before the insertion into the injection molding tool.

17. The method of claim 11, wherein a carbon fiber-reinforced plastic tube is used for the production of the crossmember, the method further comprising the step of:
generating a corrosion protection layer at least along one contact surface between the carbon fiber-reinforced tube and a metallic component from the group comprising attachment structures, inlays, bolts, wherein the generation of a corrosion protection layer comprises the application of a layer made from a non-carbon fiber-reinforced thermoplastic made from a glass fiber-reinforced thermoplastic, to the carbon fiber-reinforced plastic tube along the contact surface or coating the metallic component, or
inserting at least one corrosion protection element from the group comprising bushes, flat washers, at least along a contact surface between the carbon fiber-reinforced plastic tube and the metallic component, wherein the corrosion protection element is formed from a glass fiber-reinforced thermoplastic.

18. A crossmember arrangement, comprising:
a crossmember; and
at least one attachment structure that is connected to the crossmember in a non-releasable manner, wherein the at least one attachment structure is configured to attach a component to the crossmember,
wherein the crossmember consists of a thermoplastic fiber-reinforced plastic tube and is pressed in with the attachment structure, wherein the crossmember and the attachment structure are connected at least in a firmly bonded manner by the thermoplastic matrix of the fiber-reinforced plastic tube and are insert molded with a plastic structure.

19. The crossmember arrangement of claim 18, wherein the attachment structure is
a load application element for a connecting point of the crossmember to an A pillar, wherein the load application element comprises a self-stamping bush, an inlay, or a conical element group,
an airbag holder,
a steering console, or
a tunnel brace.

20. The crossmember arrangement of claim 18, wherein
the injected plastic structure is a rib structure and consists of fiber-reinforced, thermoplastic material that is polyamide (PA) or polyphthalamide (PPA), or
the crossmember arrangement has a corrosion protection layer or a corrosion protection element from the group comprising bushes, flat washers, between the crossmember that consists of a carbon fiber-reinforced plastic tube, and a metallic component from the group comprising attachment structure, inlays, bolts, wherein the corrosion protection layer or the corrosion protection element consists of a glass fiber-reinforced thermoplastic, or the metallic component has a galvanic coating.
